(19) United States
(12) Patent Application Publication
(10) Pub. No.: US 2010/0266060 A1
(43) Pub. Date: Oct. 21, 2010

(54) RADIO COMMUNICATION DEVICE AND METHOD FOR DETERMINING DELAY AMOUNT OF CDD

(75) Inventors: Ryohei Kimura, Kanagawa (JP); Shinsuke Takaoka, Kanagawa (JP); Masayuki Hoshino, Kanagawa (JP); Katsuhiko Hiramatsu, Leuven (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/668,653

(22) PCT Filed: Jul. 11, 2008
(86) PCT No.: PCT/JP2008/001872

§ 371 Date: Jan. 11, 2010

(30) Foreign Application Priority Data
Jul. 12, 2007 (JP) 2007-183475
Feb. 7, 2008 (JP) 2008-027755

(51) Int. Cl. H04B 7/02

(52) U.S. Cl. 375/267

(57) ABSTRACT

A radio communication device capable of obtaining the frequency diversity effect when a CDD is used for the open-loop transmission. A CDD control information determination section (101) on the radio communication device determines the number of cyclic delay shift samples given to transmission data to be transmitted from each of antennas (109-1) to (109-4) such that a combination of two antennas maximizing the difference between the number of two cyclic delay shift samples given to the transmission data to be transmitted from each of two antennas is changed sequentially over time in all the combinations of any two antennas among the antennas (109-1) to (109-4). Cyclic delay sections (105-1) to (105-4) give each different cyclic delay to each data symbol assigned to a plurality of sub-carriers among multiplexed signals that are input from an arrangement section (104) according to the number of cyclic delay shift samples to be input from the CDD control information determination section (101).

### TECHNICAL FIELD

The present invention relates to a radio communication apparatus and a method of determining the amount of CDD delay.

BACKGROUND ART

In recent years, transmission techniques for realizing high speed and high capacity data transmission have been studied, and a MIMO (Multi Input Multi Output) transmission technique using a plurality of antennas has been the focus of attention. MIMO transmission allows increased throughput by providing a plurality of antennas both on the transmission side and the receiving side, by preparing a plurality of channels in space between radio transmission and radio reception, and, by spatially multiplexing the channels.

Further, studies are conducted for the cyclic delay diversity (CDD, see non-patent document 1) technique as a peripheral technique of MIMO transmission, whereby, by transmitting signals to which different cyclic delays are given on a per antenna basis from a plurality of antennas at the same time, delay spread is equally increased to improve the frequency selectivity of a fading channel. Here, the size of delay spread is based on the difference between the channel gain of each antenna and the number of cyclic delay shift samples, which determines the amount of CDD delay to give to data symbols transmitted from that antenna. To be more specific, delay spread becomes greater when the difference between the numbers of cyclic delay shift samples to give to data symbols transmitted from two respective antennas having greater channel gain, is greater. Further, it is possible to provide greater frequency diversity effect when the greater delay spread is acquired.

Further, in CDD, open-loop transmission, whereby a predetermined number of cyclic delay shift samples is given to a data symbol and the data symbol with the cyclic delay shift is transmitted, is possible (e.g. Non-Patent Document 2).
Non-Patent Document 1: 3GPP, R1-051354, Samsung, “Adaptive Cyclic Delay Diversity,” RAN1#43, Seoul, Korea, Nov. 7-10, 2005
Non-Patent Document 2: 3GPP, R1-063345, LGE, “CDD-based Precoding for E-UTRA downlink MIMO,” RAN1#47, Riga, Latvia, Nov. 6-10, 2006

### DISCLOSURE OF INVENTION

### Problems to be Solved by the Invention

The number of cyclic delay shift samples is determined in advance in a radio communication base station apparatus (hereinafter simply “base station”) performing open-loop transmission, and therefore the size of delay spread is influenced by the fluctuation of channel gain in time fading for each antenna. Further, when moving speed of a radio communication mobile station apparatus (hereinafter, simply “mobile station”) is slow, the fluctuation of channel gain in time fading for each antenna become moderate. When the fluctuation of channel gain in time fading for each antenna is moderate during communication and the difference between two numbers of cyclic delay shift samples to give to data symbols transmitted individually from two respective antennas having great channel gain is small, a little delay spread continues, and frequency diversity effect becomes always little. In this way, in open-loop transmission, when the fluctuation of channel gain in time fading for each antenna is moderate, frequency diversity effect may not be provided.

It is therefore an object of the present invention to provide a radio communication apparatus and method of determining the amount of CDD delay that make it possible to provide frequency diversity effect when CDD is used in open-loop transmission.

### Means for Solving the Problem

The radio communication apparatus of the present invention provides a radio communication apparatus transmitting multicarrier signals formed with a plurality of subcarriers based on cyclic delay diversity and adopts a configuration including: a determination section that determines a plurality of amounts of delay of cyclic delay diversity to give to the multicarrier signals transmitted from a plurality of antennas such that, from all combinations formed with two antennas among the plurality of antennas, a combination maximizing a difference between two amounts of delay of cyclic delay diversity to give to the multicarrier signals transmitted individually from the two antennas varies sequentially over time; and a delay section that gives the plurality of determined amounts of delay of cyclic delay diversity to the multicarrier signals.

### ADVANTAGEOUS EFFECTS OF INVENTION

According to the present invention, it is possible to provide frequency diversity effect when CDD is used in open-loop transmission.

### BRIEF DESCRIPTION OF DRAWINGS

FIG. 1 is a block diagram of a base station according to Embodiment 1 of the present invention;

FIG. 2 shows patterns of the number of cyclic delay shift samples according to Embodiment 1 of the present invention;

FIG. 3 shows the fluctuation of channel gain in time fading according to Embodiment 1 of the present invention;

FIG. 4 shows delay spread over time in all combinations of antennas according to Embodiment 1 of the present invention;

FIG. 5 shows relationships between the maximum Doppler cycle and shift cycle, according to Embodiment 1 of the present invention;

FIG. 6 is a block diagram of the mobile station according to Embodiment 1 of the present invention;

FIG. 7 shows patterns of the number of cyclic delay shift samples according to Embodiment 2 of the present invention;

FIG. 8 shows delay spread over time in all combinations of antennas according to Embodiment 2 of the present invention;

FIG. 9 shows relationships between the maximum Doppler cycle and shift cycle, according to Embodiment 2 of the present invention;

FIG. 10 is a block diagram of a base station according to Embodiment 3 of the present invention;

FIG. 11 shows patterns of transmission power parameters according to Embodiment 3 of the present invention;

FIG. 12 shows transmission power control of an OFDM symbol according to Embodiment 3 of the present invention;

FIG. 13 shows patterns of mapping density parameters according to Embodiment 3 of the present invention;

FIG. 14 illustrates examples of mapping common reference signals according to Embodiment 3 of the present invention;

FIG. 15 shows combination patterns in the frequency domain according to Embodiment 4 of the present invention;

FIG. 16 shows combination patterns in the time domain and the frequency domain according to Embodiment 4 of the present invention;

FIG. 17 illustrates a mobile communication system using MBMS according to Embodiment 5 of the present invention;

FIG. 18A shows patterns of the number of cyclic delay shift samples according to Embodiment 5 of the present invention (control information determination method 1);

FIG. 18B shows patterns of transmission power parameters according to Embodiment 5 of the present invention (control information determination method 1);

FIG. 18C shows patterns of mapping density parameters according to Embodiment 5 of the present invention (control information determination method 1);

FIG. 19 shows combination patterns of the base stations according to Embodiment 5 of the present invention (control information determination method 1);

FIG. 20 shows combination patterns in the time domain and the frequency domain according to Embodiment 5 of the present invention (control information determination method 1);

FIG. 21 shows combination patterns of the base stations according to Embodiment 5 of the present invention (control information determination method 2); and

FIG. 22 shows combination patterns in the time domain and the frequency domain according to Embodiment 5 of the present invention(control information determination method 2).

### BEST MODE FOR CARRYING OUT THE INVENTION

Now, embodiments of the present invention will be described in detail with reference to the accompanying drawings.

### Embodiment 1

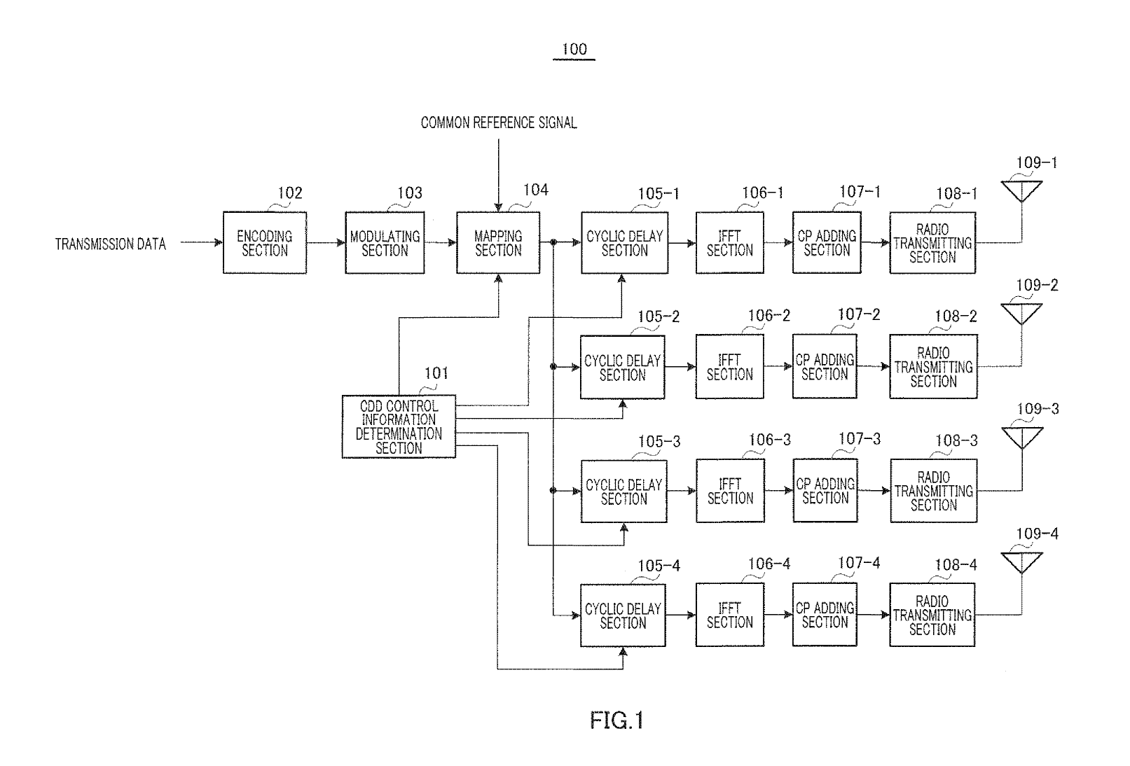

FIG. 1 shows the configuration of base station 100 according to the present embodiment.

In base station 100 shown in FIG. 1, CDD control information determination section 101 determines the number of cyclic delay shift samples to give to each data symbol transmitted from antennas 109-1 to 109-4. To be more specific, CDD control information determination section 101 determines the numbers of cyclic delay shift samples to give to data symbols transmitted individually from antennas 109-1 to 109-4 such that, in all combinations formed with two antennas among antennas 109-1 to 109-4, a combination that maximizes the difference between two numbers of cyclic delay shift samples to give to data symbols transmitted from two antennas, varies sequentially over time. Further, CDD control information determination section 101 generates a control signal showing the determined antenna-specific numbers of cyclic delay shift samples. Then, CDD control information determination section 101 outputs varying numbers of cyclic delay shift samples to cyclic delay sections 105-1 to 105-4, respectively. The CDD delay amount determination process in CDD control information determination section 101 will be described later.

Encoding section 102 encodes transmission data. Then, encoding section 102 outputs the encoded transmission data to modulating section 103.

Modulating section 103 modulates the encoded transmission data received as input from encoding section 102, to generate a data symbol. Then, modulating section 103 outputs the generated data symbol to mapping section 104.

Mapping section 104 multiplexes a common reference signal, the control signal received as input from CDD control information determination section 101 and the data symbol received as input from modulating section 103, and maps the multiplexed signal to a plurality of subcarriers. Then, mapping section 104 outputs the multiplexed signal to cyclic delay sections 105-1 to 105-4.

Cyclic delay section 105-1, IFFT (Inverse Fast Fourier Transform) section 106-1, CP (Cyclic Prefix) adding section 107-1 and radio transmitting section 108-1 are provided in relationship to antenna 109-1. Also, Cyclic delay sections 105-2 to 105-4, IFFT sections 106-2 to 106-4, CP adding sections 107-2 to 107-4 and radio transmitting sections 108-2 to 108-4 are provided in relationship to antennas 109-2 to 109-4.

Cyclic delay sections 105-1 to 105-4 give varying cyclic delays to the data symbols mapped to a plurality of subcarriers in the multiplexed signals received as input from mapping section 104, according to the numbers of cyclic delay shift samples received as input from CDD control information determination section 101. Then, cyclic delay sections 105-1 to 105-4 output the signals after cyclic delay to IFFT sections 106-1 and 106-4, respectively.

IFFT sections 106-1 to 106-4 perform an IFFT for the subcarriers to which the signals after cyclic delay received as input from cyclic delay sections 105-1 to 105-4 are mapped, to generate OFDM symbols. Then, IFFT sections 106-1 to 106-4 output the OFDM symbols to CP adding sections 107-1 to 107-4, respectively.

CP adding sections 107-1 to 107-4 add the same signal as the tail part of the OFDM symbols, to the beginning of those OFDM symbols, as a CP. Then, CP adding sections 107-1 to 107-4 output the OFDM symbols after addition of a CP to radio transmitting sections 108-1 to 108-4, respectively.

Radio transmitting sections 108-1 to 108-4 perform transmitting processing including D/A conversion, amplification and up-conversion on the OFDM symbols after the addition of an CP, and transmit the OFDM symbols after transmitting processing from antennas 109-1 to 109-4 at the same time. By this means, a plurality of OFDM symbols are transmitted from a plurality of antennas using CDD.

Next, the CDD delay amount determination processing in CDD control information determination section 101 will be described in detail.

Here, assume that the data length of a data symbol received as input from modulating section 103 is N symbols. Accordingly, the difference between the numbers of cyclic delay shift samples is N/2 at maximum. Further, the number of antennas is four, and therefore CDD control information determination section 101 uses four values spaced equally from a zero to N/2 as the numbers of cyclic delay shift samples. That is, CDD control information determination section 101 determines the number of cyclic delay shift samples to give to the data symbol transmitted from each antenna to be either 0, N/6, N/3 or N/2. Further, assume that the unit transmission interval is 1 TTI (Transmission Time Interval).

Further, when the number of antennas is four, there are total twelve (=₄P₂) patterns of combinations formed with two antennas. However, a combination configured with two antennas is compared with a combination formed with the same two antennas and having a different order, the numbers of cyclic delay shift samples to give are only exchanged each other and the difference between the numbers of cyclic delay shift samples between combinations do not change, and therefore, the size of the delay spread are identical. For example, the case where a zero is given to a data symbol transmitted from antenna 109-1 and N/2 is given to a data symbol transmitted from antenna 109-2 and the case where N/2 is given to a data symbol transmitted from antenna 109-1 and a zero is given to a data symbol transmitted from antenna 109-2 are identical each other in the sizes of delay spread. That is, regardless of what numbers of cyclic delay shift samples given to data symbols transmitted from two antennas respectively are any values, the sizes of delay spread are identical as long as the difference between the numbers is the same. Consequently, when the number of antennas is four, there are total six (=₄C₂) patterns, half of twelve patterns of combinations formed with two antennas.

Then, CDD control information determination section 101 determines the four numbers of cyclic delay shift samples to give to data symbols transmitted individually from antennas 109-1 to 109-4 such that, among six patterns of combinations, a combination in which the difference between two numbers of cyclic delay shift samples to give to data symbols transmitted from two antennas is N/2, varies sequentially over 6 TTIs.

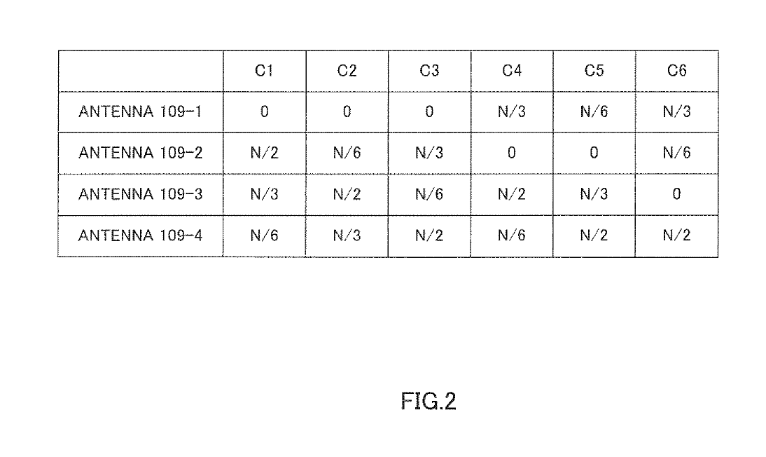

To be more specific, CDD control information determination section 101 determines combinations of combination numbers C1 to C6 shown in FIG. 2, as combinations of four numbers of cyclic delay shift samples in TTI 1 to TTI 6. That is, combination number C1 shown in FIG. 2 is associated with TTI 1, and CDD control information determination section 101 determines the number of cyclic delay shift samples to give to a data symbol transmitted from antenna 109-1 to be a zero, the number of cyclic delay shift samples to give to a data symbol transmitted from antenna 109-2 to be N/2, the number of cyclic delay shift samples to give to a data symbol transmitted from antenna 109-3 to be N/3, and the number of cyclic delay shift samples to give to a data symbol transmitted from antenna 109-4 to be N/6. That is, with TTI 1 (combination number C1), the difference between the two numbers of cyclic delay shift samples to give to data symbols transmitted from antennas 109-1 and 109-2 respectively, become the maximum value (N/2).

Similarly, combination number C2 shown in FIG. 2 is associated with TTI 2, and CDD control information determination section 101 determines the number of cyclic delay shift samples to give to a data symbol transmitted from antenna 109-1 to be a zero, the number of cyclic delay shift samples to give to a data symbol transmitted from antenna 109-2 to be N/6, the number of cyclic delay shift samples to give to a data symbol transmitted from antenna 109-3 to be N/2, and the number of cyclic delay shift samples to give to a data symbol transmitted from antenna 109-4 to be N/3. That is, with TTI 2 (combination number C2), the difference between the two numbers of cyclic delay shift samples to give to data symbols transmitted from antennas 109-1 and 109-3 respectively, become the maximum value (N/2).

Similarly, combination numbers C3 to C6 shown in FIG. 2 are associated with TTI 3 to TTI 6, and CDD control information determination section 101 determines the number of cyclic delay shift samples to give to a data symbol transmitted from each antenna.

By using the combinations shown in FIG. 2, CDD control information determination section 101 changes the combination of antennas in which the difference between the two numbers of cyclic delay shift samples is the maximum value (N/2), per TTI. Further, the two numbers of cyclic delay shift samples belonging to each combination (combination numbers C1 to C6) becomes the maximum in one of TTI 1 to TTI 6. That is, a cycle of shift patterns of the numbers of cyclic delay shift samples is 6 TTIs. By this means, regardless of which of antennas 109-1 to 109-4 has great channel gain, the difference between the numbers of cyclic delay shift samples always becomes the maximum over time in 6 TTIs.

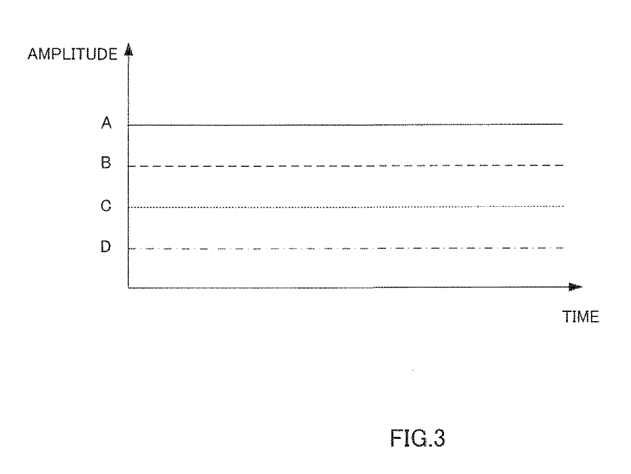

Next, as shown in FIG. 3, the delay spread over time when the channel gains of antennas 109-1 to 109-4 are amplitude A, B, C or D, will be explained. In FIG. 3, the fluctuation of channel gain in time fading is moderate and the order (ranking) of the magnitude of amplitudes A to D does not change. As described above, delay spread is influenced more by the number of cyclic delay shift samples given to a data symbol transmitted from an antenna with greater channel gain. That is, delay spread is determined according to the difference between the number of cyclic delay shift samples given to a data symbol transmitted from the antenna with the channel gain of amplitude A and the number of cyclic delay shift samples given to a data symbol transmitted from the antenna with the channel gain of amplitude B.

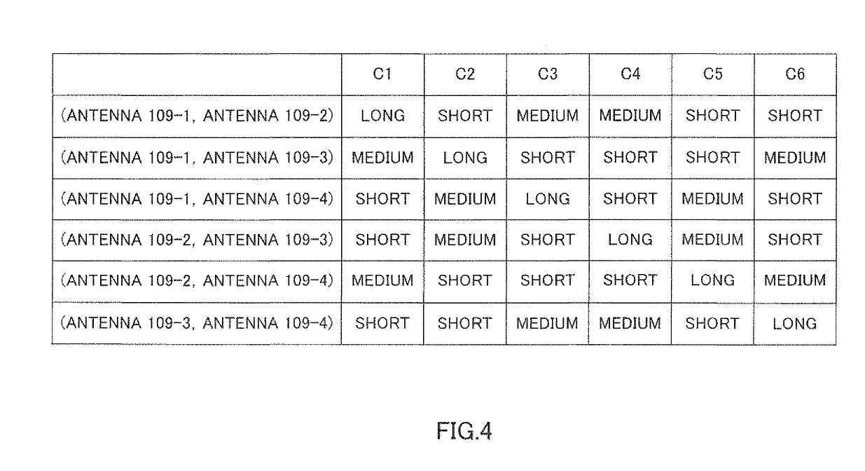

Then, FIG. 4 shows the delay spread over time in TTI 1 to TTI 6 (combination numbers C1 to C6) when the channel gains of two antennas belonging to combinations are amplitude A and amplitude B. In FIG. 4, delay spread is “long” when the difference between the numbers of cyclic delay shift samples is N/2, delay spread is “medium” when the difference between the numbers of cyclic delay shift samples is N/3, and delay spread is “short” when the difference between the numbers of cyclic delay shift samples is N/6.

When the channel gains of antennas 109-1 and 109-2 are amplitude A and amplitude B, in TTI 1 (combination number C1), the difference between the two numbers of cyclic delay shift samples (a zero and N/2) for antennas 109-1 and 109-2 is N/2 and therefore the delay spread is “long.” Further, in TTI 2 (combination number C2), the difference between the two numbers of cyclic delay shift samples (a zero and N/6) for antennas 109-1 and 109-2 is N/6 and therefore the delay spread is “short,” in TTI 3 (combination number C3),the difference between the two numbers of cyclic delay shift samples (a zero and N/3) for antennas 109-1 and 109-2 is N/3 and therefore the delay spread is “medium,” in TTI 4 (combination number C4), the difference between the two numbers of cyclic delay shift samples (N/3 and a zero) for antennas 109-1 and 109-2 is N/3, and therefore the delay spread is “medium,” in TTI 5 (combination number C5), the difference between the two numbers of cyclic delay shift samples (N/6 and a zero) for antennas 109- 1 and 109-2 is N/6 and therefore the delay spread is “short,” and in TTI 6 (combination number C6), the difference between the two numbers of cyclic delay shift samples (N/3 and N/6) for antennas 109-1 and 109-2 is N/6 and therefore the delay spread is “short.” The same applies to other combinations shown in FIG. 4.

As shown in FIG. 4, in any antenna combinations, delay spread acquired in TTI 1 to TTI 6 (combination numbers C1 to C6) are one “large”, two of “medium”, and three of “short.” That is, it is possible to acquire different size of delay spread over TTI 1 to TTI 6 (combination numbers C1 to C6) equally even when channel gain of one of antenna combinations increases. Accordingly, even when the channel gain of one of antenna combinations decreases, by acquiring average delay spread, it is possible to prevent frequency diversity effect from being always small.

Next, the relationships between the maximum Doppler cycle, which shows the channel fluctuation cycle produced by move by a mobile station, and a shift cycle of the number of cyclic delay shift samples. Here, assume that 1 TTI is 1 msec.

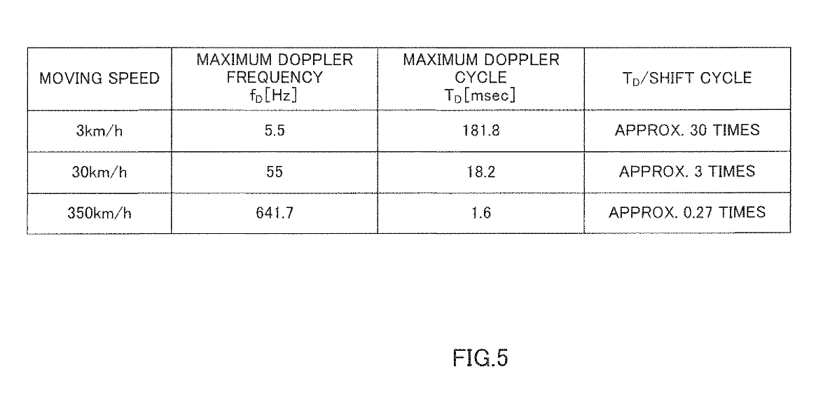

As shown in FIG. 5, if mobile station 200 moves at high speed of 350 km/h, the maximum Doppler cycle is 1.6 msec. This is about 0.27 times as long as 6 TTIs (6 msec), which is the shift cycle of the number of cyclic delay shift samples. Accordingly, in high-speed movement, the ranking of channel gains in time fading varies significantly at time intervals shorter than 6 TTIs. That is, even when the number of cyclic delay shift samples to give to a data symbol transmitted from each antenna is fixed, the channel gain of each antenna varies significantly during communication, so that it is possible to provide frequency diversity effect.

Meanwhile, as shown in FIG. 5, if mobile station 200 moves at low speed of 3 km/h, the maximum Doppler cycle is 181.8 msec. This is about 30 times as long as 6 TTIs (6 msec), which is a shift cycle of the number of cyclic delay shift samples. Accordingly, channel gain in time fading for each antenna slowly varies during communication as shown in FIG. 3. However, even when the ranking of channel gains is not anticipated to change as shown in FIG. 3, base station 100 shifts the number of cyclic delay shift samples for each antenna at a substantially shorter time interval than the maximum Doppler cycle, and it is possible to acquire delay spreads of different sizes every TTI. This makes it possible to average delay spread in 6 TTIs of a shift cycle. That is, even when channel gain in time fading varies slowly as low-speed movement, by varying delay spread in mobile station 200 significantly, it is possible to produce effect equivalent to the fluctuation of channel gain in time fading in high-speed movement, and provide frequency diversity effect regardless of the magnitude of channel gain of each antenna.

As shown in FIG. 5, if mobile station 200 moves at medium speed of 30 km/h, the maximum Doppler cycle is 18.2 msec. This is about three times as long as 6 TTIs (6 msec), which is a shift cycle of the number of cyclic delay shift samples. Accordingly, base station 100 produces frequency diversity effect by shifting the number of cyclic delay shift samples and time diversity effect by averaging the fluctuation of channel gain in time fading.

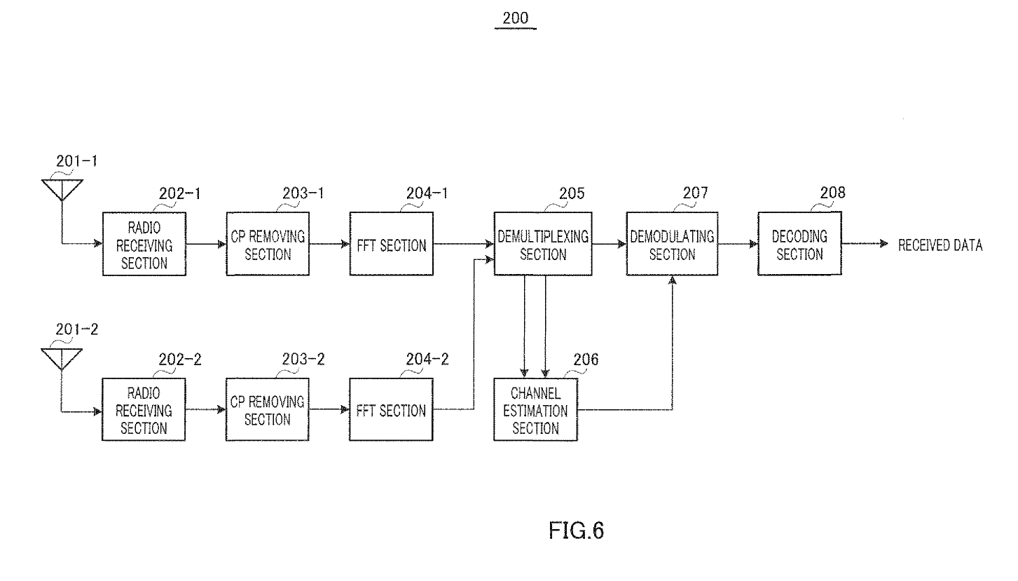

Next, FIG. 6 shows the configuration of mobile station 200 according to the present embodiment.

In mobile station 200 shown in FIG. 6, radio receiving section 202-1, CP removing section 203-1 and FFT section 204-1 are provided in relationship to antenna 201-1. Further, radio receiving section 202-2, CP removing section 203-2 and FFT section 204-2 are provided in relationship to antenna 201-2.

Radio receiving sections 202-1 and 202-2 receive OFDM symbols, which are multicarrier signals transmitted with CDD from base station 100 (FIG. 1), via antenna 201-1 and 201-2, respectively, and perform receiving processing including down-conversion and AID conversion on these OFDM symbols. Then, radio receiving sections 202-1 and 202-2 output the OFDM symbols after the radio receiving processing to CP removing sections 203-1 and 203-2, respectively.

CP removing sections 203-1 and 203-2 remove the CPs from the OFDM symbols received as input from radio receiving sections 202-1 and 202-2, respectively. Then, CP removing sections 203-1 and 203-2 output the OFDM symbols without CPs to FFT sections 204-1 and 204-2, respectively.

FFT sections 204-1 and 204-2 perform an FFT on the OFDM symbols received as input from CP removing sections 203-1 and 203-2, respectively, and transform the time domain signals to frequency domain signals. Then, FFT sections 204-1 and 204-2 output the signals after the FFT to demultiplexing section 205.

Demultiplexing section 205 demultiplexes the signals after the FFT received as input from FFT sections 204-1 and 204-2 into data symbols, common reference signals and control signals. Then, demultiplexing section 205 outputs the data symbols to demodulating section 207, and the common reference signals and the control signals to channel estimation section 206.

Meanwhile, channel estimation section 206 performs channel estimation on the common reference signals received as input from demultiplexing section 205 based on the numbers of cyclic delay shift samples designated by the control signals received as input from demultiplexing section 205. To be more specific, channel estimation section 206 first performs channel estimation per antenna using common reference signals arranged on a per antenna basis. Then, channel estimation section 206 gives varying cyclic delays per antenna to channel estimation values per antenna and performs channel estimation on the common reference signals after cyclic delay. In this way, in channel estimation section 206, by giving the same cyclic delay of data signals to common reference signals, it is possible to reflect the influence of fading channels by CDD of the data signals for channel estimation values of the common reference signals. Then, channel estimation section 206 outputs the estimated channel estimation value to demodulating section 207.

Demodulating section 207 demodulates the data symbols received as input from demultiplexing section 205 based on the channel estimation value received as input from channel estimation section 206. Then, demodulating section 207 outputs the data signal after the demodulation to decoding section 208.

Decoding section 208 decodes the data signal after the demodulation received as input from demodulating section 207. Then, decoding section 208 outputs the data signal after the decoding as received data.

In this way, according to the present embodiment, the difference between two numbers of cyclic delay shift samples to give to data symbols transmitted from two antennas belonging to each combination varies equally over time. That is, the combination that maximizes the difference between two numbers of cyclic delay shift samples to give to data symbols transmitted from two antennas belonging to each combination varies sequentially over time. By this means, it is possible to average the sizes of delay spread in all combinations. Consequently, according to the present embodiment, in the case where CDD transmission is performed in open-loop transmission, even when channel gain in time fading for each antenna varies slowly, it is possible to acquire constant frequency diversity effect.

### Embodiment 2

With Embodiment 1, a case has been explained where the difference between two numbers of cyclic delay shift samples to give to data symbols transmitted from two antennas belonging to one combination in the same TTI becomes the maximum. By contrast with this, with the present embodiment, a case will be explained where the number of cyclic delay shift samples is determined such that a plurality of combinations that maximize the difference between the two numbers of cyclic delay shift samples to give to data symbols transmitted from two antennas are provided in the same TTI.

Now, the operations of CDD control information determination section 101 according to the present embodiment will be explained.

Here, similar to Embodiment 1, assume that the data length of a data symbol received as input from modulating section 103 is N symbols. Further, the number of antennas is four, and CDD control information determination section 101 uses values of integral multiples of N/4 in which a value from a zero to N is divided into four equal parts as the numbers of cyclic delay shift samples. That is, CDD control information determination section 101 determines the number of cyclic delay shift samples to give to a data symbol transmitted from each antenna, to be a zero, N/4, N/2 or 3N/4. By this means, the difference between a zero and N/2 is N/2, and, in addition, the difference between N/4 and 3N/4 is also N/2. That is, it is possible to include two patterns of combinations that maximize the difference between numbers of cyclic delay shift samples (N/2) in the same TTI among all six patterns of combinations. This means that the maximum difference between numbers of cyclic delay shift samples for arbitrary combinations of antennas is N/2.

Then, CDD control information determination section 101 determines four numbers of cyclic delay shift samples to give to data symbols transmitted individually from antennas 109-1 to 109-4, such that, in six patterns of combinations in the same TTI, CDD control information determination section 101 provides two combinations, which match half the number of antennas, that maximize the difference between two numbers of cyclic delay shift samples to give to data symbols transmitted from two antennas, N/2.

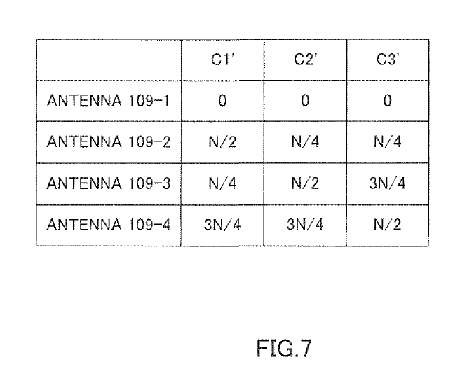

To be more specific, CDD control information determination section 101 determines combinations of combination numbers C1′ to C3′ shown in FIG. 7, as combinations of four numbers of cyclic delay shift samples in TTI 1 to TTI 3. That is, combination number C1′ shown in FIG. 7 is associated with TTI 1, and CDD control information determination section 101 determines the number of cyclic delay shift samples to give to a data symbol transmitted from antenna 109-1 to be a zero, determines the number of cyclic delay shift samples to give to a data symbol transmitted from antenna 109-2 to be N/2, determines the number of cyclic delay shift samples to give to a data symbol transmitted from antenna 109-3 to be N/4, and determines the number of cyclic delay shift samples to give to a data symbol transmitted from antenna 109-4 to be 3N/4. That is, with TTI 1 (combination number C1′), the difference between the two numbers of cyclic delay shift samples to give to data symbols transmitted from antennas 109-1 and 109-2 is N/2, and the difference between the numbers of cyclic delay shift samples to give to data symbols transmitted from antennas 109-3 and 109-4 is N/2.

Similarly, combination number C2′ shown in FIG. 7 is associated with TTI 2, and CDD control information determination section 101 determines the number of cyclic delay shift samples to give to a data symbol transmitted from antenna 109-1 to be a zero, determines the number of cyclic delay shift samples to give to a data symbol transmitted from antenna 109-2 to be N/4, determines the number of cyclic delay shift samples to give to a data symbol transmitted from antenna 109-3 to be N/2, and determines the number of cyclic delay shift samples to give to a data symbol transmitted from antenna 109-4 to be 3N/4. That is, with TTI 2 (combination number C2′), the difference between the numbers of cyclic delay shift samples to give to data symbols transmitted from antennas 109-1 and 109-3 is N/2 and the difference between the numbers of cyclic delay shift samples to give to data symbols transmitted from antennas 109-2 and 109-4 is N/2.

The same applies to TTI 3, that is, CDD control information determination section 101 determines combination number C3′ shown in FIG. 7 as the number of cyclic delay shift samples to give to a data symbol transmitted from each antenna.

As shown in FIG. 7, CDD control information determination section 101 provides, in the same TTI, two combinations that maximize the difference between two numbers of cyclic delay shift samples, N/2. Further, the difference between two numbers of cyclic delay shift samples belonging to combinations (combination numbers C1′ to C3′) becomes the maximum in one of TTI 1 to TTI 3. That is, a cycle of shift patterns of the numbers of cyclic delay shift samples is reduced to 3 TTIs half of the TTIs in Embodiment 1.

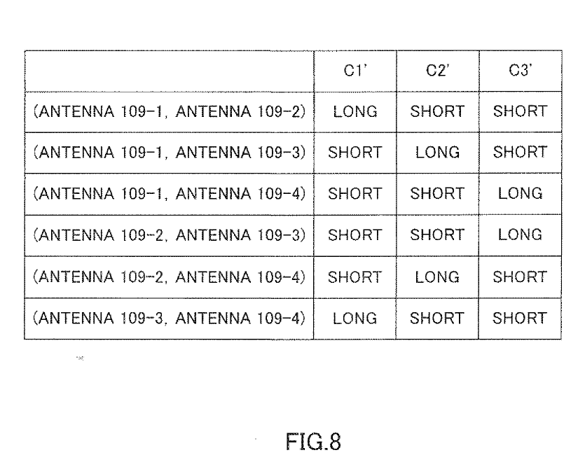

Next, FIG. 8 shows the delay spread over time in TTI 1 to TTI 3 (combination numbers C1′ to C3) where channel gain of each antenna belonging to the combinations of antennas is either amplitude A or B, as in Embodiment 1 (FIG. 3). Although with Embodiment 1, the delay spread is “short” when the difference between numbers of cyclic delay shift samples is N/6, in FIG. 8, the delay spread is “short” when the difference between numbers of cyclic delay shift samples is N/4.

When the channel gains of antennas 109-1 and 109-2 are amplitude A and amplitude B, in TTI 1 (combination number C1′), the difference between the two numbers of cyclic delay shift samples (a zero and N/2) for antennas 109-1 and 109-2 is N/2 and therefore the delay spread is “long.” Further, in TTI 2 (combination number C2′), the difference between the two numbers of cyclic delay shift samples (a zero and N/4) for antennas 109-1 and 109-2 is N/4, and therefore delay spread is “short,” and, in TTI (combination number C3′), the difference between the two numbers of cyclic delay shift samples (a zero and N/4) for antennas 109-1 and 109-2 is N/4 and therefore delay spread is “short.” The same applies to combinations of other antennas shown in FIG. 8.

As shown in FIG. 8, in any antenna combinations, delay spread in TTI 1 to TTI 3 (combination numbers C1′ to C3′) are “long” and two of “short.” That is, it is possible to acquire different size of delay spread over TTI 1 to TTI 3 (combination numbers C1′ to C3′) equally even when channel gain of one of antenna combinations increases. By this means, it is possible to make the shift cycle of the number of cyclic delay shift samples half the shift cycle in Embodiment 1. Further, the “short” delay spread shown in FIG. 8 is longer than the “short” delay spread shown in FIG. 4, so that it is possible to produce greater frequency diversity effect than the configuration in FIG. 4 in each TTI (each combination number).

Further, for example, in TTI 1 (combination number C1′ shown in FIG. 8), delay spread is “long” when the channel gains of antennas 109-1 and 109-2 are amplitude A and amplitude B and the channel gains of antennas 109-3 and 109-4 are amplitude A and amplitude B. That is, there are two antenna combinations in which the difference between the numbers of cyclic delay shift samples in 1 ITT can be N/2. By this means, it is possible to average delay spread efficiently in half the period in Embodiment 1.

Next, the relationships between the maximum Doppler cycle and the shift cycle of the number of cyclic delay shift samples. Here, assume that 1 TTI is 1 msec as in Embodiment 1.

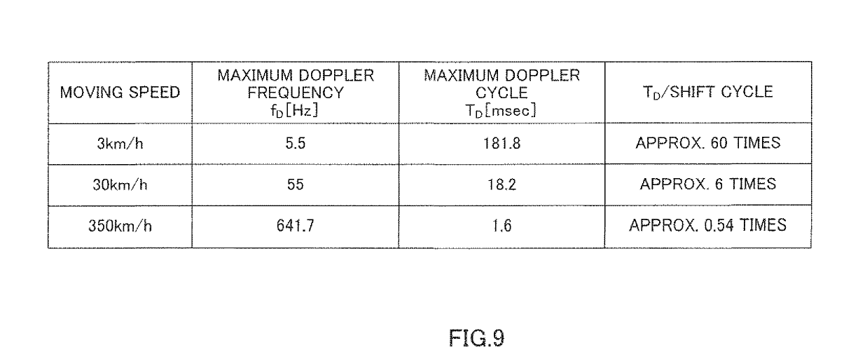

As shown in FIG. 9, the ratio between the maximum Doppler cycle and the shift cycle of the number of cyclic delay shift samples is twice as much as that in. Embodiment 1 (FIG. 5). To be more specific, if mobile station 200 moves at low speed of 3 km/h, the maximum Doppler cycle is about sixty times as long as the shift cycle of the number of cyclic delay shift samples. Accordingly, it is possible to average delay spread at shorter intervals than the maximum Doppler cycle during communication. Further, if mobile station 200 moves at medium speed of 30 km/h, the maximum Doppler cycle is about six times as long as the shift cycle of the number of cyclic delay shift samples, and it is possible to improve the effect of averaging delay spread by shifting the number of cyclic delay shift samples compared to the case in Embodiment 1.

In this way, according to the present embodiment, in the same TTI, a plurality of combinations that maximize the difference between two numbers of cyclic delay shift samples to give to data symbols transmitted from two antennas are provided, so that the combinations that maximize the difference between the numbers of cyclic delay shift samples in the same TTI increase compared with Embodiment 1, and the possibility to acquire longer delay spread increases. Consequently, according to the present embodiment, it is possible to acquire the same effect in shorter time than in Embodiment 1.

Further, according to the present embodiment, it is possible to reduce control information reported from the base station to a mobile station compared with Embodiment 1. To be more specific, although three bits are required because information in six patterns is provided with Embodiment 1, only two bits may be required because information in three patterns is provided with the present embodiment. Further, it is possible to reduce the amount of memory to hold the patterns of the numbers of cyclic delay shift samples in the base station and a mobile station.

### Embodiment 3

With the present embodiment, the base station determines transmission power for OFDM symbols (formed with data symbols and common reference signals) transmitted from antennas, and mapping density for common reference signals per unit transmission interval, according to the number of cyclic delay shift samples that varies over time.

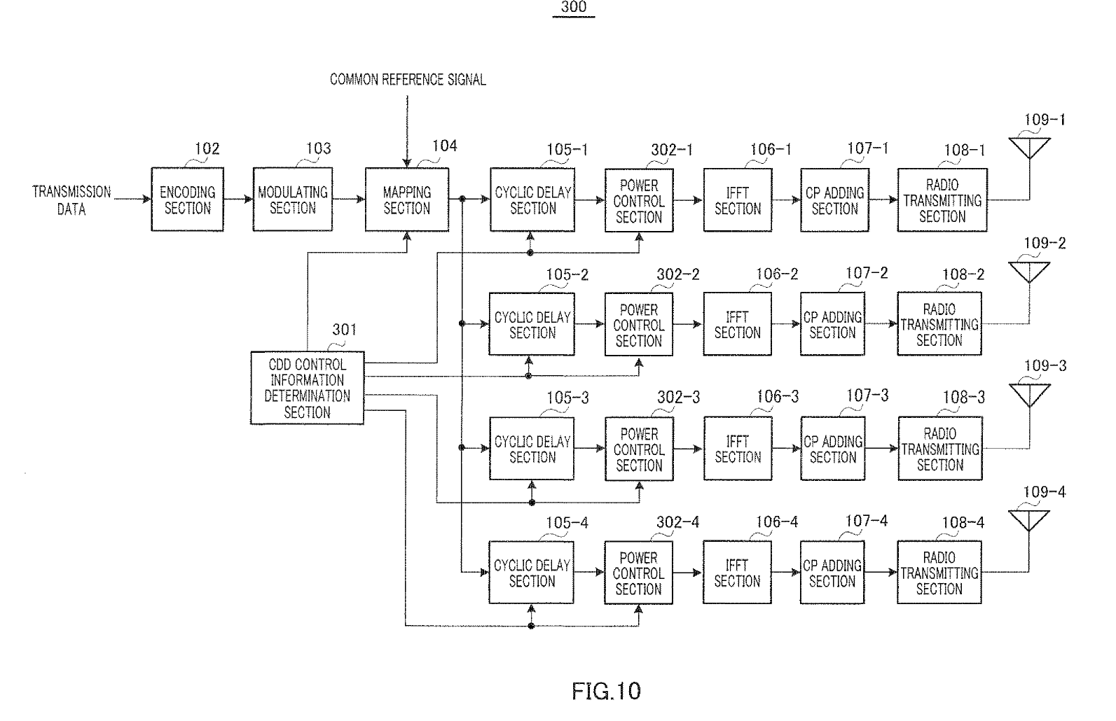

FIG. 10 shows the configuration of base station 300 according to the present example, In FIG. 10, the same components will be assigned the same reference numerals as in Embodiment 1 (FIG. 1), and therefore the description thereof will be omitted.

In base station 300 shown in FIG. 10, CDD control information determination section 301 determines the numbers of cyclic delay shift samples to give to data symbols transmitted from antennas 109-1 to 109-4, transmission power for OFDM symbols transmitted from antennas 109-1 to 109-4, and the mapping density for common reference signals transmitted from antennas 109-1 to 109-4 per unit transmission interval. To be more specific, CDD control information determination section 301 first determines the numbers of cyclic delay shift samples as in Embodiment 1. Then, CDD control information determination section 301 determines transmission power for OFDM symbols transmitted individually from antennas such that, in all combinations formed with two antennas among antennas 109-1 to 109-4, the transmission power for the OFDM symbols transmitted from the two antennas forming the combination that maximizes the difference between the two numbers of cyclic delay shift samples to give to the OFDM symbols transmitted from the two antennas is made higher, and the transmission power for the OFDM symbols transmitted from the antennas other than the two antennas forming the combination that maximizes the difference between the two numbers of cyclic delay shift samples is made lower. Further, CDD control information determination section 301 determines the mapping density for common reference signals transmitted per unit transmission interval from the antennas such that the mapping density for common reference signals per unit transmission interval transmitted from the two antennas forming the combination that maximizes the difference between two numbers of cyclic delay shift samples is made higher, and the mapping density for common reference signals transmitted per unit transmission interval from antennas other than the two antennas forming the combination that maximizes the difference between two numbers of cyclic delay shift samples is made lower. Then, CDD control information determination section 301 outputs control signals formed with the determined number of cyclic delay shift samples for the antennas, the transmission power parameters designating transmission power for the antennas, and the mapping density parameters designating the mapping density for common reference signals for the antennas, to mapping section 104, cyclic delay sections 105-1 to 105-4 and power control sections 302-1 to 302-4. The CDD control information determination process in CDD control information determination section 301 will be described later.

Mapping section 104 maps common reference signals to a plurality of subcarriers forming an OFDM symbol according to mapping density parameters shown in the control signal received as input from CDD control information determination section 301.

Cyclic delay sections 105-1 to 105-4 give varying cyclic delays to data symbols mapped to a plurality of subcarriers in the multiplexed signals received as input from mapping section 104, according to the numbers of cyclic delay shift samples shown in the control signal received as input from CDD control information determination section 301. Here, cyclic delay sections 105-1 to 105-4 do not give cyclic delay to the common reference signals. Then, cyclic delay sections 105-1 to 105-4 output the signals after cyclic delay to power control sections 302-1 to 302-4, respectively.

Power control sections 302-1 to 302-4 are provided in relationship to antennas 109-1 to 109-4, respectively. Power control sections 302-1 to 302-4 control transmission power for the OFDM symbols after cyclic delay received as input from cyclic delay sections 105-1 to 105-4 according to the transmission power parameters shown in the control signal received as input from CDD control information determination section 301. That is, power control sections 302-1 to 302-4 control transmission power for the data symbols and the common reference signals in the OFDM symbols.

Meanwhile, channel estimation section 206 in mobile station 200 (FIG. 6) performs channel estimation on the common reference signals received as input from demultiplexing section 205 using the control signal received as input from demultiplexing section 205. To be more specific, channel estimation section 206 specifies the common reference signals for antennas mapped to a plurality of subcarriers forming an OFDM symbol based on the mapping density parameters shown in the control signal. Then, channel estimation section 206 performs channel estimation per antenna using the common reference signals for the antennas. Next, based on the number of cyclic delay shift samples shown by the control signal, channel estimation section 206 gives varying cyclic delays per antenna to channel estimation values per antenna and performs channel estimation on the common reference signals after cyclic delay.

Next, the CDD control information determination processing in CDD control information determination section 301 will be described in detail.

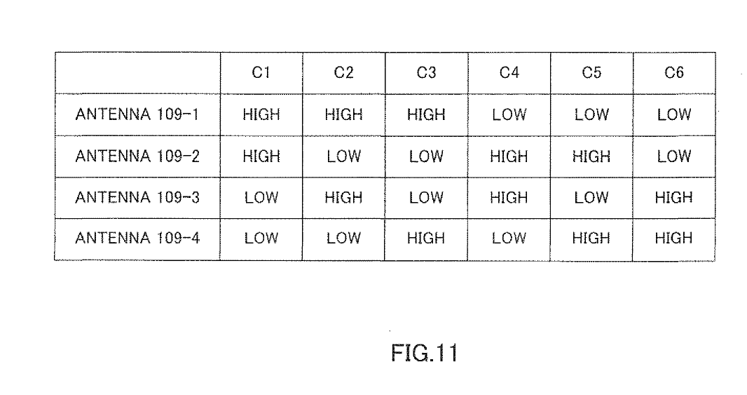

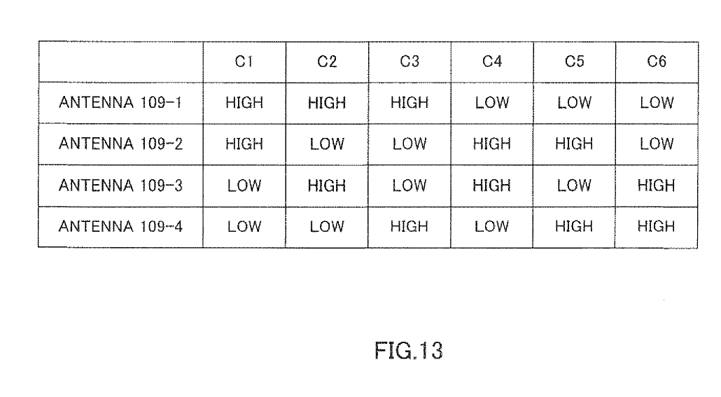

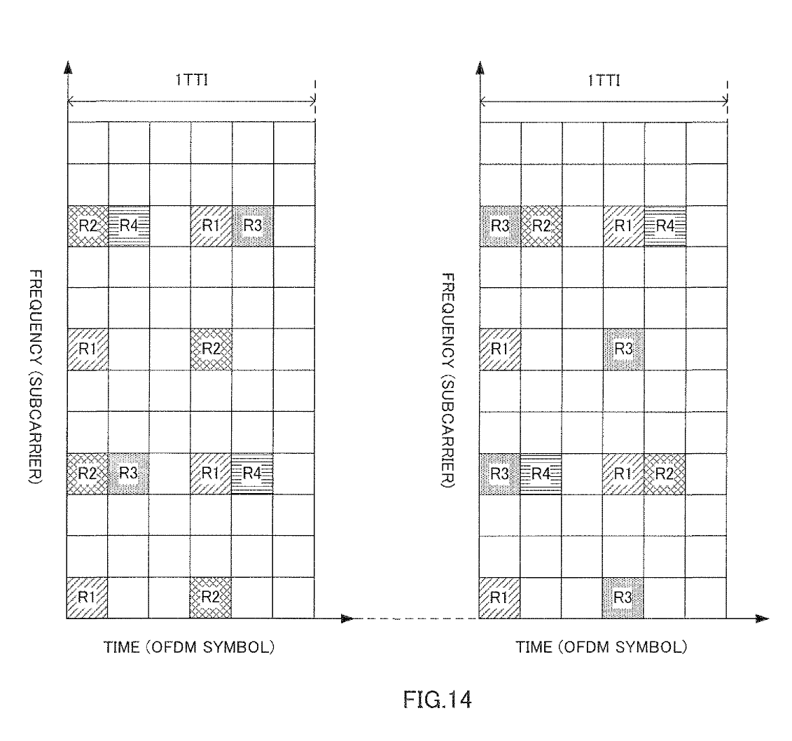

Here, as in Embodiment 1, assume that the data length of a data symbol received as input from modulating section 103 is N symbols. Accordingly, the difference between the numbers of cyclic delay shift samples is N/2 at maximum. That is, CDD control information determination section 301 determines the number of cyclic delay shift samples to give to the data symbol transmitted from each antenna to be either 0, N/6, N/3 or N/2. Here, as combinations of the numbers of cyclic delay shift samples in the individual unit transmission intervals TTI 1 to TTI 6, the combinations (combination numbers C1 to C6) of cyclic delay shift samples shown in FIG. 2 of Embodiment 1 are used. Further, combination numbers C1 to C6 showing the combinations of the transmission power parameters shown in FIG. 11 and the mapping density parameters shown in FIG. 13 correspond to the unit transmission intervals TTI 1 to TTI 6. That is, base station 300 determines the combinations of combination numbers C1 to C6 as the combinations of the numbers of cyclic delay shift samples, the transmission power parameters and the mapping density parameters in the individual unit transmission intervals TTI 1 to TTI 6. Accordingly, base station 300 uses combination numbers C1 to C6 as a control signal transmitted to mobile station 200. For example, in TTI 2, base station 300 transmits combination number C2 as a control signal, and mobile station 200 uses the parameters of combination number C2 in FIGS. 2, 11 and 13 as control information. Further, block units, where a plurality of subcarriers forming an OFDM symbol are grouped into several blocks, are referred to as “subcarrier blocks.” In FIG. 14, twelve subcarriers forming an OFDM symbol are one subcarrier block. Further, in one TTI, which is the unit transmission interval, and one subcarrier block, which is the block unit in the frequency domain, the mapping density for common reference signals transmitted individually from antennas 109-1 to 109-4 varies between the antennas. To be more specific, in one TTI, there are antennas for which the number of common reference signals mapped to subcarriers forming OFDM symbols (the 12 subcarriers forming subcarrier blocks shown in FIG. 14) is four and there are antennas for which the number of common reference signals mapped to subcarriers forming OFDM symbols (the 12 subcarriers forming subcarrier blocks shown in FIG. 14) is two.

First, CDD control information determination section 301 determines the four numbers of cyclic delay shift samples to give to data symbols transmitted individually from antennas 109-1 to 109-4 in each TTI as in Embodiment 1. For example, as shown in FIG. 2, CDD control information determination section 301 determines combinations (combination numbers C1 to C6) of the four numbers of cyclic delay shift samples to give to data symbols transmitted individually from antennas 109-1 to 109-4 in TTI 1 to TTI 6 as in Embodiment 1. By this means, as in Embodiment 1, the difference between the numbers of cyclic delay shift samples always becomes the maximum over time in TTI 1 to TTI 6. Further, it is possible to acquire different size of delay spread over TTI 1 to TTI 6 (combination numbers C1 to C6) equally as shown in FIG. 4 in Embodiment 1 even when channel gain of one of antenna combinations increases.

Next, CDD control information determination section 301 determines transmission power for OFDM symbols transmitted individually from antennas 109-1 to 109-4 based on the combinations of the numbers of cyclic delay shift samples shown in FIG. 2. That is, CDD control information determination section 301 determines the transmission power parameters for OFDM symbols transmitted individually from antennas 109-1 to 109-4 such that the transmission power for the OFDM symbol transmitted from the two antennas forming the combination that maximizes the difference between the two numbers of cyclic delay shift samples to give to the data symbols transmitted from the two antennas, N/2, is made higher, and the transmission power for the OFDM symbol transmitted from antennas other than the two antennas forming the combination that maximizes the difference between the two numbers of cyclic delay shift samples, N/2, is made lower.

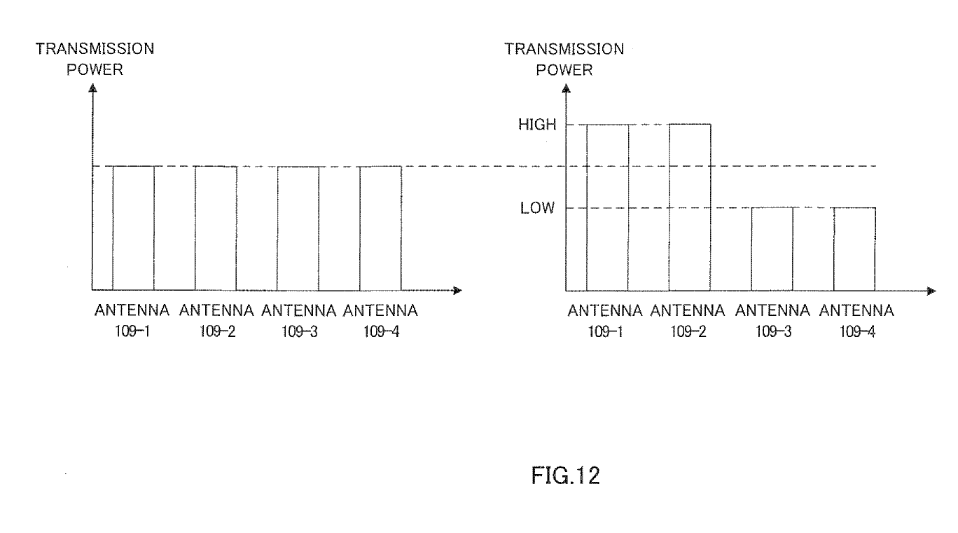

Here, FIG. 11 shows the combinations (combination numbers C1 to C6) of transmission power parameters in TTI 1 to TTI 6. In FIG. 11, the transmission power parameters are “high” when the transmission power of each antenna before transmission power control shown in the left of FIG. 12 is increased by a predetermined amount. Meanwhile, the transmission power parameters are “low” when transmission power is decreased by the same predetermined amount as in a case where transmission power is increased. That is, the total transmission power before transmission power control and the total transmission power after transmission power control are the same.

Accordingly, in TTI 1 (combination number C1), the difference between the two numbers of cyclic delay shift samples (a zero and N/2) for antennas 109-1 and 109-2 shown in FIG. 2 is N/2, and therefore CDD control information determination section 301 determines the transmission power parameters for antennas 109-1 and 109-2 to be “high” as shown in FIG. 11. Meanwhile, CDD control information determination section 301 determines the transmission power parameters for antennas 109-3 and 109-4, other than antennas 109-1 and 109-2, to be “low.”

Similarly, in TTI 2 (combination number C2), the difference between the two numbers of cyclic delay shift samples (a zero and N/2) for antennas 109-1 and 109-3 shown in FIG. 2 is N/2, and therefore CDD control information determination section 301 determines the transmission power parameters for antennas 109-1 and 109-3 to be “high” as shown in FIG. 11. Meanwhile, CDD control information determination section 301 determines the transmission power parameters for antennas 109-2 and 109-4, other than antennas 109-1 and 109-3, to be “low.” The same applies to TTI 3 to TTI 6 (combination numbers C3 to C6), and CDD control information determination section 301 determines the transmission power parameters for OFDM symbols transmitted from the antennas.

Then, transmission control sections 302-1 to 302-4 shown in FIG. 10 control transmission power for OFDM symbols according to the transmission power parameters shown in FIG. 11. For example, in TTI 1 (combination number C1), as shown in FIG. 11, the transmission power parameters for antennas 109-1 and 109-2 are “high.” Accordingly, as shown in the right of FIG. 12, transmission power control sections 302-1 and 302-2 corresponding to antennas 109-1 and 109-2 make transmission power for OFDM symbols higher. Meanwhile, as shown in FIG. 11, the transmission power parameters for antennas 109-3 and 109-4 are “low.” As shown in the right of FIG. 12, transmission power control sections 302-3 and 302-4 corresponding to antennas 109-3 and 109-4 make transmission power for OFDM symbols lower. The same applies to TTI 2 to TTI 6 (combination numbers C2 to C6).

As described above, when the channel gain of each antenna is great and the difference between the numbers of cyclic delay shift samples is great, the delay spread becomes longer. Accordingly, base station 300 makes the transmission power for OFDM symbols transmitted from the antennas that maximize the difference between the numbers of cyclic delay shift sample higher, so that mobile station 200 can acquire longer delay spread. That is, regardless of which of antennas 109-1 to 109-4 has great channel gain, the mobile station 200 can acquire longer delay spread in TTI 1 to 6 (combination numbers C1 to C6).

Next, CDD control information determination section 301 determines mapping density for common reference signals transmitted individually from antennas 109-1 to 109-4, based on the combinations of the numbers of cyclic delay shift samples shown in FIG. 2. That is, CDD control information determination section 301 determines the mapping density parameters for common reference signals transmitted individually from antennas 109-1 to 109-4 such that the mapping density per TTI for common reference signals transmitted from the two antennas forming the combination that maximizes the difference between the two numbers of cyclic delay shift samples to give to the data symbols transmitted from the two antennas, N/2, is made higher, and the mapping density per TTI for common reference signals transmitted from antennas other than the two antennas forming the combination that maximizes the difference between the two numbers of cyclic delay shift samples, N/2, is made lower.

Here, FIG. 13 shows the combinations (combination numbers C1 to C6) of mapping density parameters in TTI 1 to TTI 6. In FIG. 13, the mapping density parameters are “high” when the mapping density for common reference signals is made higher. Meanwhile, the mapping density parameters are “low” when the mapping density for common reference signals is made lower. Accordingly, when the mapping density parameters are “high,” four common reference signals are mapped to subcarriers forming OFDM symbols, and, when the mapping density parameters are “low,” two common reference signals are mapped to subcarriers forming OFDM symbols.

Accordingly, in TTI 1 (combination number C1), the difference between the two numbers of cyclic delay shift samples (a zero and N/2) for antennas 109-1 and 109-2 shown in FIG. 2 is N/2, and therefore CDD control information determination section 301 determines the mapping density parameters for antennas 109-1 and 109-2 to be “high” as shown in FIG. 13. Meanwhile, CDD control information determination section 301 determines the mapping density parameters for antennas 109-3 and 109-4, other than antennas 109-1 and 109-2, to be “low.”

Similarly, in TTI 2 (combination number C2), the difference between the two numbers of cyclic delay shift samples (a zero and N/2) for antennas 109-1 and 109-3 shown in FIG. 2 is N/2, and therefore CDD control information determination section 301 determines the mapping density parameters for antennas 109-1 and 109-3 to be “high” as shown in FIG. 13. Meanwhile, CDD control information determination section 301 determines the mapping density parameters for antennas 109-2 and 109-4, other than antennas 109-1 and 109-3, to be “low.” The same applies to TTI 3 to TTI 6 (combination numbers C3 to C6), and CDD control information determination section 301 determines the mapping density parameters for OFDM symbols transmitted from the antennas.

Then, mapping section 104 shown in FIG. 10 maps common reference signals to a plurality of subcarriers according to the mapping density parameters shown in FIG. 13. For example, in TTI 1 (combination number C1), as shown in FIG. 13, the mapping density parameters for antennas 109-1 and 109-2 are “high.” Accordingly, as shown in the left of FIG. 14, mapping section 104 maps common reference signal R1 transmitted from antenna 109-1 and common reference signal R2 transmitted from antenna 109-2, to four positions in subcarriers forming an OFDM symbol (in the 12 subcarriers forming one subcarrier block). Further, as shown in FIG. 13, the mapping density parameters for antennas 109-3 and 109-4 are “low.” Accordingly, as shown in the left of FIG. 14, mapping section 104 maps common reference signal R3 transmitted from antenna 109-3 and common reference signal R4 transmitted from antenna 109-4 to two positions in subcarriers forming an OFDM symbol (in the 12 subcarriers forming one subcarrier block).

Further, in TTI 2 (combination number C2), as shown in FIG. 13, the mapping density parameters for antennas 109-1 and 109-3 are “high,” Accordingly, as shown in the right of FIG. 14, mapping section 104 maps common reference signal R1 transmitted from antenna 109-1 and common reference signal R3 transmitted from antenna 109-3 to four positions in subcarriers forming an OFDM symbol (in the 12 subcarriers forming one subcarrier block). Further, as shown in FIG. 13, the mapping density parameters for antennas 109-2 and 109-4 are “low.” Accordingly, as shown in the right of FIG. 14, mapping section 104 maps common reference signal R2 transmitted from antenna 109-2 and common reference signal R4 transmitted from antenna 109-4 to two positions in subcarriers forming an OFDM symbol (in the 12 subcarriers forming one subcarrier block). The same applies to TTI 3 to TTI 6 (combination numbers C3 to C6).

In this way, in TTI 1 to TTI 6 (combination numbers C1 to C6), as in the above-described transmission power control for OFDM symbols, the mapping density for common reference signals transmitted from the two antennas forming the combination that maximizes the difference between the two numbers of cyclic delay shift samples to give to data symbols transmitted from the two antennas, N/2, becomes higher. By this means, by controlling the two antennas forming the combination that maximizes the difference between two numbers of cyclic delay shift samples, N/2, such that the mapping density for common reference signals becomes high, it is possible to map more common reference signals. Further, by controlling the two antennas forming the combination that maximizes the difference between two numbers of cyclic delay shift samples, N/2, such that the transmission power for common reference signals becomes high, it is possible to assign higher transmission power. For this reason, it is possible to receive more common reference signals of good received quality in mobile station 200 (FIG. 6). Accordingly, channel estimation section 206 in mobile station 200 is able to measure channel estimation values using more common reference signals of good received quality, so that the accuracy of channel estimation improves.

In this way, according to the present embodiment, a multicarrier signal transmitted from the antennas forming the combination that maximizes the difference between two numbers of cyclic delay shift samples is made higher and the mapping density per unit transmission interval for common reference signals transmitted from those antennas is made higher. By this means, an antenna with great channel gain is able to acquire longer delay spread at certain time intervals, so that frequency diversity effect further improves. Further, the mapping density per unit transmission interval for common reference signals transmitted from an antenna with high transmission power becomes high, so that the accuracy of channel estimation further improves in the mobile station.

Although a case has been explained with the present embodiment where the mapping density for common reference signals transmitted from antennas varies between antennas, mapping section 104 does not perform mapping processing according to the mapping density parameters if the mapping density is uniform between common reference signals transmitted from antennas.

Further, although a case has been explained with the present embodiment where the mapping density control for common reference signals by mapping section 104 and the power control for common reference signals by power control sections 302-1 to 302-4 are carried out at the same time, with the present invention, the mapping density control for common reference signals by mapping section 104 and the power control for common reference signals by power control sections 302-1 to 302-4 may be carried out individually. For example, if the mapping density for common reference signals by mapping section 104 is controlled only, channel estimation section 206 of mobile station 200 (FIG. 6) is able to perform channel estimation using more common reference signals transmitted from the two antennas, which provide dominant influence on the accuracy of channel estimation, and which form the combination that maximizes the difference between two numbers of cyclic delay shift samples, N/2. Consequently, channel estimation section 206 makes possible improved accuracy of channel estimation. Further, if the power for common reference signals by power control sections 302-1 to 302-4 is controlled only, by improving channel gain of the two antennas which provide dominant influence on the accuracy of channel estimation and of which form a combination that maximizes the difference between two numbers of cyclic delay shift samples N/2, so that channel estimation section 206 makes possible improved accuracy of channel estimation of common reference signals after cyclic delay.

### Embodiment 4

With the present embodiment, in the same unit transmission interval, the combination that maximizes the difference between two numbers of cyclic delay shift samples transmitted from two antennas to give to data symbols varies also between different frequencies.

Now, the operations of CDD control information determination section 301 (FIG. 10) according to the present embodiment will be explained.

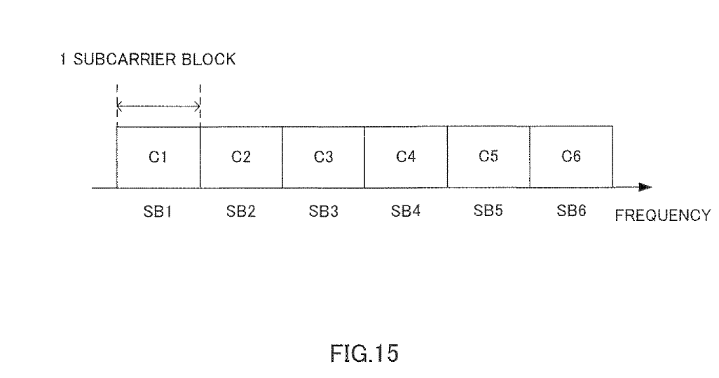

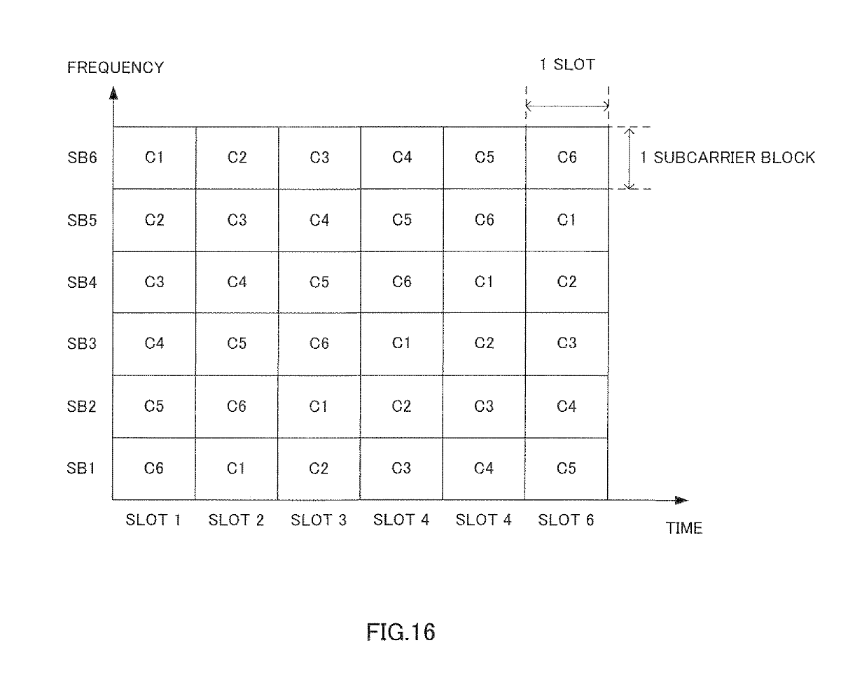

Here, similar to Embodiment 3, assume that the data length of a data symbol received as input from modulating section 103 is N symbols. Combination numbers C1 to C6 shown in FIGS. 15 and 16 correspond to combination numbers C1 to C6 in FIGS. 2, 11 and 13 as in Embodiment 3. Further, assume that the unit transmission interval in the time domain is one slot (1 TTI). Further, several neighboring sub carriers are grouped into blocks as subcarrier block units in the frequency domain. A subcarrier block may be referred to as a “resource block (RB)” or a “subcarrier group.” Further, as shown in FIG. 16, assume that a block formed with one slot and one subcarrier block is the CDD change unit. Further, each CDD change unit includes at least one of common reference signals R1 to R4 transmitted from antennas 109-1 to 109-4 respectively.

CDD control information determination section 301 according to the present embodiment determines a plurality of numbers of cyclic delay shift samples such that the combination that maximizes the difference between two numbers of cyclic delay shift samples to give to data symbols transmitted from two antennas varies between different subcarrier blocks in the same slot.

For example, as shown in FIG. 15, CDD control information determination section 301 determines control information about subcarrier block 1 (hereinafter simply “SB”) based on combination number C1. That is, CDD control information determination section 301 determines, for antenna 109-1 for example, the number of cyclic delay shift samples as a zero referring from FIG. 2, the transmission power parameters “high” from FIG. 11 and the mapping density parameters “high” from FIG. 13. The same applies to antennas 109-2 and 109-4.

Similarly, as shown in FIG. 15, CDD control information determination section 301 determines control information based on combination number C2 in SB2. That is, CDD control information determination section 301 determines for antenna 109-1 for example, the number of cyclic delay shift samples as a zero referring from FIG. 2, the transmission power parameters “high” from FIG. 11 and the mapping density parameters “high” from FIG. 13. The same applies to antennas 109-2 to 109-4.

Further, also in SB3 to SB6, CDD control information determination section 301 each determines the number of cyclic delay shift samples, the transmission power parameters, and the mapping density parameters based on combination numbers C3 to C6.

In this way, CDD control information determination section 301 changes sequentially control information formed with the number of cyclic delay shift samples, the transmission power parameters and the mapping density parameters for antennas 109-1 to 109-4, between different frequencies in the same slot and over time in the same subcarrier block.

For example, as shown in FIG. 16, CDD control information determination section 301 determines the control information associated with combination number C6 for antennas 109-1 to 109-4 in the CDD change unit formed with slot 1 and SB 1, and the control information associated with combination number C5 for antennas 109-1 to 109-4 in the CDD change unit formed with slot 1 and SB 2. The same applies to CDD change units formed with slot 1 and SB 3 to SB 6.

Similarly, as shown in FIG. 16, CDD control information determination section 301 determines the control information associated with combination number CI for antennas 109-1 to 109-4 in the CDD change unit formed with slot 2 and SB 1, and the control information associated with combination number C6 for antennas 109-1 to 109-4 in the CDD change unit formed with slot 2 and SB 2. The same applies to CDD change units formed with slot 2 and SB 3 to SB 6.

Also in slots 3 to 6, CD control information determination section 301 determines the control information for antennas 109-1 to 109-4 in CDD change units formed with the slots and SB 1 to SB 6 in the same way.

As shown in FIG. 16, in different CDD change units in the same slot (e.g. SB 1 to SB 6 in slot 1), control information associated with varying combination numbers is determined, and, in different CDD change units in the same SB (e.g. slot 1 to slot 6 in SB 1), control information associated with varying combination numbers is determined. By this means, in the time domain, as in Embodiment 3, it is possible to average the fluctuation of channel gain in time fading at given time intervals (slot 1 to slot 6 shown in FIG. 16) even when channel gain in time fading for each antenna varies slowly. Similarly, in the frequency domain, it is possible to average the fluctuation of channel gain in frequency fading in given frequency bands (SB 1 to SB 6) even when channel gain in frequency fading for each antenna varies slowly. Consequently, in a case where CDD transmission is performed with open-loop transmission, even when channel gain in frequency fading as well as channel gain in time fading for each antenna varies slowly, it is possible to improve the effect of averaging delay spread and provide more constant frequency diversity effect.

Further, at least one of common reference signals R1 to R4 transmitted from antennas 109-1 to 109-4 is mapped in each CDD change unit. That is, common reference signals R1 to R4 are mapped equally in certain time intervals (slot 1 to slot 6) and the certain frequency bands (SB 1 to SB 6) shown in FIG. 16. Consequently, mobile station 200 (FIG. 6) is able to acquire uniform channel estimation values over certain time intervals and certain frequency bands. Further, by making mapping density higher for common reference signals transmitted from the two antennas forming the combination that maximizes the difference between the numbers of cyclic delay shift samples delay, N/2, within a CDD change unit, it is possible to improve the accuracy of channel estimation in mobile station 200 (FIG. 6).

In this way, according to the present embodiment, it is possible to average channel gains in fading in the time domain and the frequency domain. By this means, it is possible to improve the effect of averaging delay spread, and therefore provide greater frequency diversity effect.

### Embodiment 5

With the present embodiment, a case will be explained where multimedia broadcast/multicast service (MBMS) is employed.

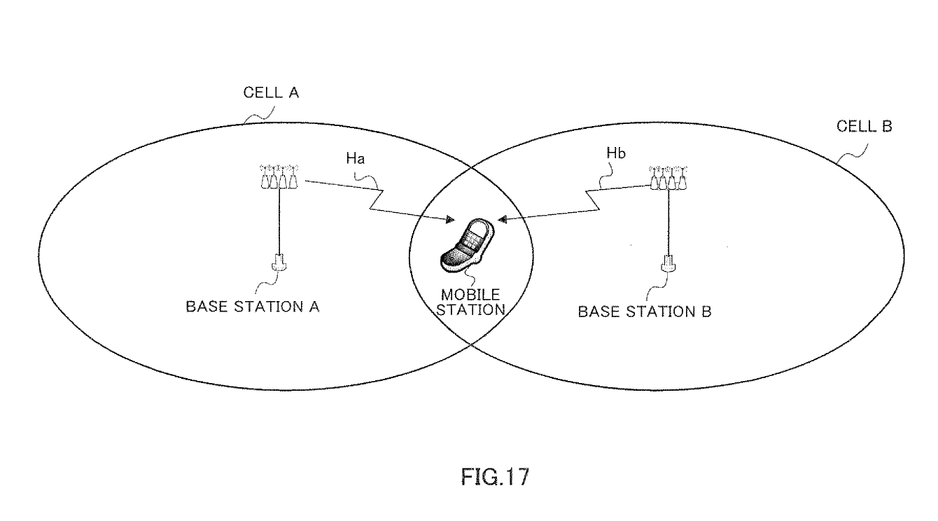

As shown in FIG. 17, in MBMS, a plurality of base stations (base station A and base station B) transmit the same data to a mobile station located in a cell boundary at the same time using the same frequency band. By this means, a mobile station is able to provide site diversity effect and improve received quality by combining the same data from a plurality of base stations (i.e. site diversity combining).

Here, as shown in FIG. 17, assume that the channel gain from base station A is Ha and the channel gain from base station B is Hb. Ha and Hb are both complex numbers. For example, when Ha and Hb are substantially the same (Ha=Hb), that is, when the correlation value between Ha and Hb is close to 1, the mobile station does not provide site diversity effect. Further, when the amplitude of Ha and the amplitude of Hb are substantially the same and the phase of Ha and the phase of Hb are anti-phase (Ha=−Hb), that is, when the correlation value between Ha and Hb is close to −1, the channel gains are compensated, and the mobile station acquires very little channel gain.

Therefore, when the channel gains of base stations A and B vary slowly, the situation where site diversity effect is not provided or channel gains to be acquired is little is likely to continue. By this means, the situation with small delay spread continues and frequency diversity effect is not provided.

Then, CDD control information determination section 301 in base station 300 (FIG. 10) according to the present embodiment determines a plurality of numbers of cyclic delay shift such that the combination that maximizes the difference between two numbers of cyclic delay shift samples to give to data symbols transmitted from two antennas varies between base station 300 and other base stations in the same unit transmission interval. The control information determination method in CDD control information determination section 301 will be described later.

Cyclic delay section 105-1 to 105-4 give varying cyclic delays to multiplexed signals received as input from mapping section 104, according to the numbers of cyclic delay shift samples designated by control signals received as input from CDD control information determination section 301. Here, cyclic delay sections 105-1 to 105-4 give cyclic delays both the data symbols and the common reference signals. Then, cyclic delay sections 105-1 to 105-4 output the signals after cyclic delay to power control sections 302-1 to 302-4.

Meanwhile, channel estimation section 206 in mobile station 200 (FIG. 6) according to the present embodiment performs channel estimation for common reference signals received as input from demultiplexing section 205 based on the control signals received as input from demultiplexing section 205. Here, cyclic delays are given to the common reference signals in base station 300. For this reason, channel estimation section 206 enables channel estimation for common reference signals after cyclic delay without giving varying cyclic delays per antenna to channel estimation values per antenna.

Next, the control information determination method in CDD control information determination section 301 according to the present embodiment.

(Control Information Determination Method 1)

In the present control information determination method, CDD control information determination section 301 in each base station determines a plurality of numbers of cyclic delay shift samples using varying combination patterns between that base station and other base stations.

Here, CDD control information determination section 301 in base station A shown in FIG. 17 stores combination pattern A formed with a plurality of combinations (combination numbers C1 to C6) changing, sequentially over time, the combination that maximizes the difference of the two numbers of cyclic delay shift samples to give to data symbols transmitted from two antennas. Further, CDD control information determination section 301 of base station B shown in FIG. 17 stores combination pattern B formed with a plurality of combinations (combination numbers C1 to C6) that are different from combination pattern A.

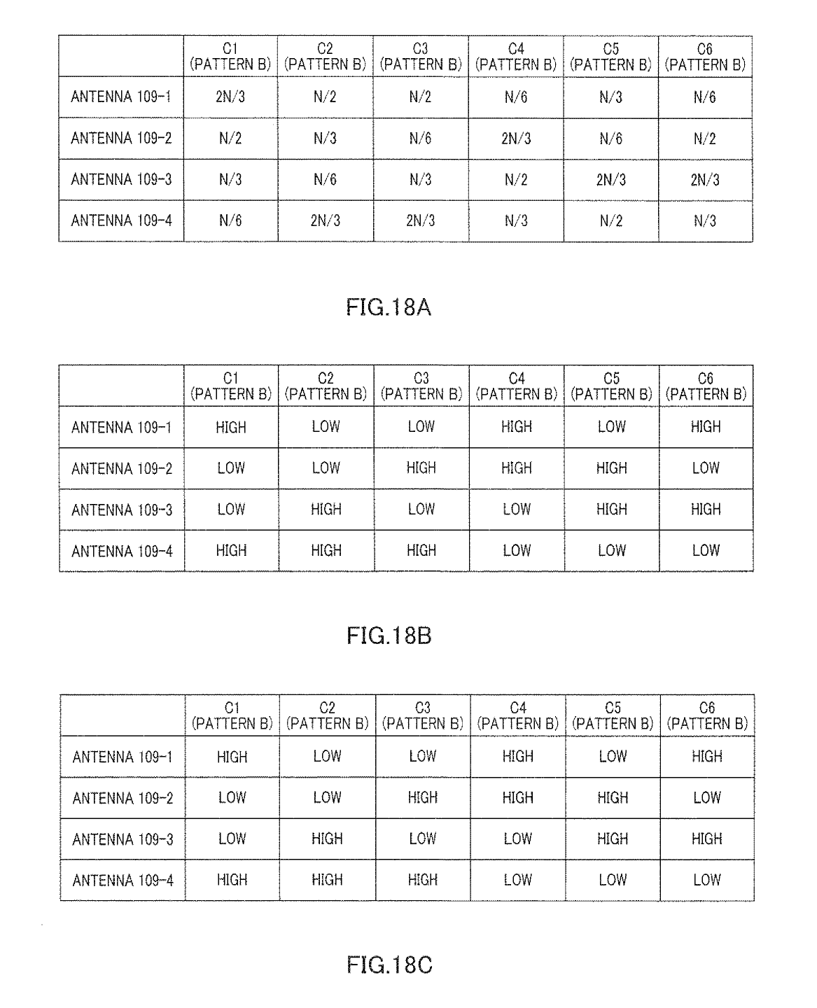

Further, CDD control information determination section 301 in base station A shown in FIG. 17 uses the combination patterns of the numbers of cyclic delay shift samples shown in FIG. 2, the transmission power parameter combination patterns shown in FIG. 11, and the mapping density combination patterns shown in FIG. 13 as combination pattern A as in Embodiment 3. Meanwhile, CDD control information determination section 301 in base station B shown in FIG. 17 uses the combination patterns of the numbers of cyclic delay shift samples shown in FIG. 18A, the transmission power parameter combination patterns shown in FIG. 18B, and the mapping density combination patterns shown in FIG. 18C as combination pattern B as in Embodiment 3.

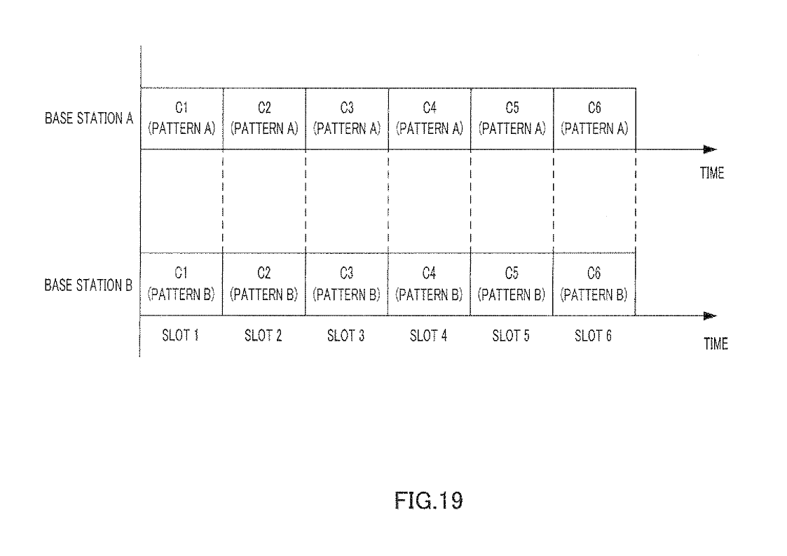

Accordingly, as shown in FIG. 19, CDD control information determination section 301 in base station A shown in FIG. 17 determines the control information associated with combination numbers C1 to C6 of combination pattern A (FIGS. 2, and 13) in slots 1 to 6. By contrast with this, as shown in FIG. 19, CDD control information determination section 301 in base station B shown in FIG. 17 determines the control information associated with combination numbers C1 to C6 of combination pattern B (FIGS. 18A, 18B and 18C) different from combination pattern A in slots 1 to 6. That is, as in Embodiment 3, each base station changes the combination that maximizes the difference between the two numbers of cyclic delay shift samples to give to data symbols transmitted from two antennas sequentially over time. By this means, mobile station 200 (FIG. 6) receiving data symbols from base station A or base station B provides the same advantage as in Embodiment 3.

Here, combination pattern A (FIG. 2) of the numbers of cyclic delay shift samples in base station A and combination pattern B (FIG. 18A) of the numbers of cyclic delay shift samples in base station B are compared. In slot 1 (combination number C1), as shown in FIG. 2, the two antennas forming the combination that maximizes the difference of cyclic delay shift samples, N/2, are antennas 109-1 and 109-2 in base station A. Meanwhile, as shown in FIG. 18A, the two antennas forming the combination that maximizes the difference of cyclic delay shift samples, N/2, are antennas 109-1 and 109-4 in base station B. Similarly, in slot 2 (combination number C2), as shown in FIG. 2, the two antennas forming the combination that maximizes the difference of cyclic delay shift samples, N/2, are antennas 109-1 and 109-3 in base station A. Meanwhile, as shown in FIG. 18A, the two antennas forming a combination that maximizes the difference of cyclic delay shift samples, N/2, are antennas 109-3 and 109-4 in base station B. That is, in the same slot (combination number), the antennas forming a combination that maximizes the difference between two cyclic delay shift samples to give to data symbols transmitted from two antennas, N/2, vary between base station A and base station B. The same applies to slots 3 to 6 (combination numbers C3 to C6).

In this way, the combination of antennas that maximize the difference between two numbers of cyclic delay shift samples varies between base station A and base station B in the same slot. Consequently, the fluctuation of channel gain Ha and the fluctuation of channel gain Hb are different in each slot. By this means, the likelihood that the channel gain of base station A and the channel gain of base station B differ in the same slot increases. Accordingly, by performing site diversity combining, mobile station 200 (FIG. 6) is able to average the channel gain fluctuations in slots 1 to 6 (combination numbers C1 to C6). That is, in mobile station 200, it is possible to reduce the likelihood that mobile station 200 is unable to provide site diversity effect, or provides very little channel gain.

In this way, according to the present control information determination method, each base station determine a plurality of numbers of cyclic delay shift samples using different combination patterns between that base station and other base stations. Consequently, by performing site diversity combining for the same data symbols transmitted from base stations at the same time in the mobile station, channel gain fluctuations from the base stations are averaged, it is possible to improve the effect of averaging delay spread. Accordingly, the mobile station acquires the effect of averaging delay spread by site diversity combining in addition to the effect of Embodiment 3, so that it is possible to provide better frequency diversity effect and improve received quality.

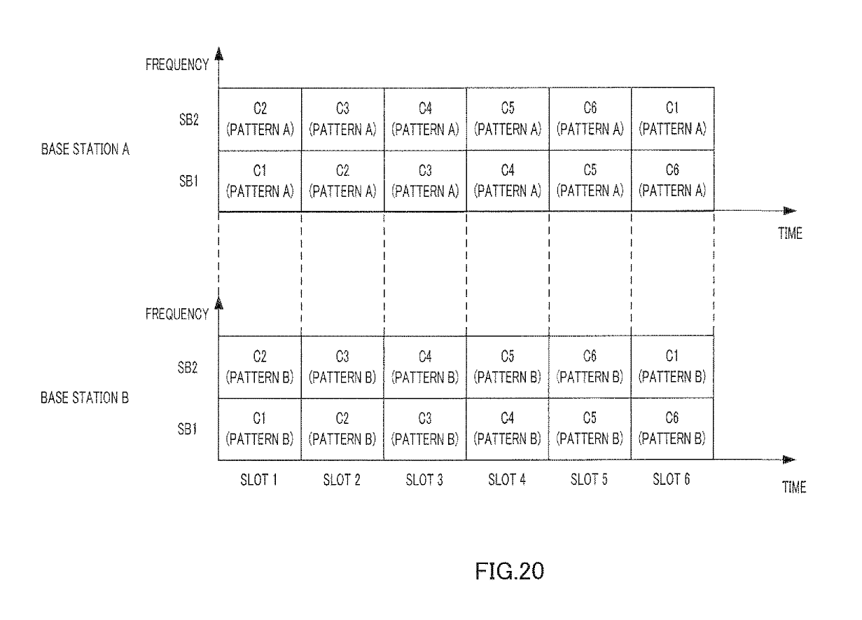

Further, although a case has been explained with this control information determination method where the combinations (combination numbers C1 to C6) vary sequentially over time, with this control information determination method, as shown in FIG. 20, CDD control information determination section 301 may determine control information using different combinations (combination numbers C1 to C6) between the time domain and the frequency domain as in Embodiment 4. By this means, it is possible to provide frequency diversity effect as well as time diversity effect.

(Control Information Determination Method 2)

In the present control information determination method, CDD control information determination section 301 in each base station determines a plurality of numbers of cyclic delay shift samples using the same combination pattern.

Here, CDD control information determination sections 301 in base stations each store the same combination pattern formed with a plurality of combinations (combination numbers C1 to C6) changing, sequentially over time, the combination that maximizes the difference of the two numbers of cyclic delay shift samples to give to data symbols transmitted from two antennas. For example, as in Embodiment 3, CDD control information determination section 301 in the base stations shown in FIG. 17 each use the combination patterns of the numbers of cyclic delay shift samples shown in FIG. 2, the transmission power parameter combination patterns shown in FIG. 11, and the mapping density combination patterns shown in FIG. 13.

CDD control information determination section 301 in each base station determines a plurality of numbers of cyclic delay shift samples by using the same combination in the same combination patterns in different unit transmission intervals between that base station and other base stations.

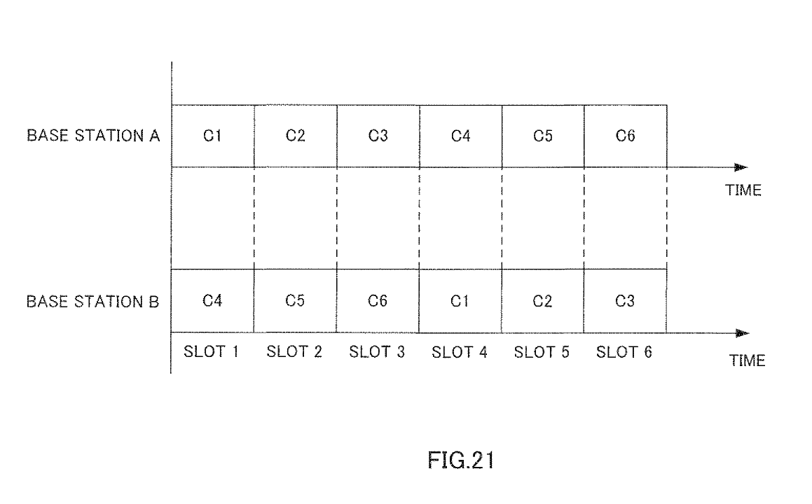

For example, CDD control information determination sections 301 in base stations each use the combination pattern in which different cyclic shifts are performed for the same combination pattern on a per base station basis. To be more specific, as shown in FIG. 21, CDD control information determination section 301 in base station A shown in FIG. 17 uses combination numbers C1 to C6 in slots 1 to 6 and determines control information. Meanwhile, CDD control information determination section 301 in base station B shown in FIG. 17 uses the combination pattern in which cyclic shift by three slots is performed for the combination pattern used in base station A in slots 1 to 6 as shown in FIG. 21. To be more specific, as shown in FIG. 21, CDD control information determination section 301 in base station B shown in FIG. 17 uses the combination numbers C4 to C6 and C1 to C3 in slots 1 to 6, and determines control information.

By this means, base station A uses the control information of combination number C1 in slot 1, and base station B uses the control information of combination number C1 in slot 4. Further, base station A uses the control information of combination number C2 in slot 2, and base station B uses the control information of combination number C2 in slot 5. That is, CDD control information determination sections 301 in base stations A and B shown in FIG. 21 use the control information of the same combination number in varying slots. The same applies to combination numbers C3 to C6.

Here, the combination pattern of the numbers of cyclic delay shift samples in base station A and the combination pattern of the numbers of cyclic delay shift samples in base station B shown in FIG. 21 are compared. In slot 1 (combination number C1), as shown in FIG. 2, the two antennas forming the combination that maximizes the difference of cyclic delay shift samples, N/2, are antennas 109-1 and 109-2 in base station A. Meanwhile, in slot 1 (combination number C4), the two antennas forming the combination that maximizes the difference of cyclic delay shift samples, N/2, are antennas 109-2 and 109-3 in base station B. Similarly, as shown in FIG. 2, in slot 2 (combination number C2), the two antennas forming the combination that maximizes the difference of cyclic delay shift samples, N/2, are antennas 109-1 and 109-3 in base station A. Meanwhile, in slot 2 (combination number C5), the two antennas forming the combination that maximizes the difference of cyclic delay shift samples, N/2, are antennas 109-2 and 109-4 in base station B. That is, as in control information determination method 1, in the same slot, the antennas forming a combination that maximizes the difference between two cyclic delay shift samples to give to data symbols transmitted from two antennas, N/2, vary between base station A and base station B. The same applies to slots 3 to 6.

By this means, the fluctuation of channel gain Ha and the fluctuation of channel gain Hb are different in each slot as in control information determination method 1. Consequently, by performing site diversity combining, mobile station 200 (FIG. 6) is able to average the channel gain fluctuations in slots 1 to 6 (combination numbers C1 to C6).

Accordingly, according to this control information determination method, it is possible to provide the same advantage as in control information determination method 1 even when the base stations use the same combination pattern.

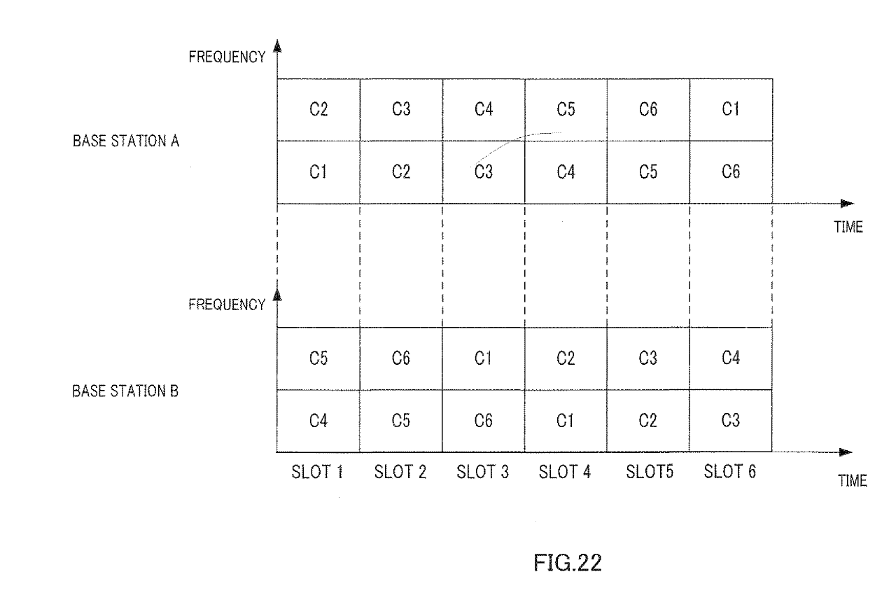

Further, although a case has been explained with this control information determination method where the combinations (combination numbers C1 to C6) vary sequentially over time, with this control information determination method, as shown in FIG. 22, CDD control information determination section 301 may determine control information using different combinations (combination numbers C1 to C6) between the time domain and the frequency domain as in Embodiment 4. By this means, it is possible to provide frequency diversity effect as well as time diversity effect.

The control information determination methods 1 and 2 have been explained.

In this way, according to the present embodiment, in a case where MBMS is employed, even when channel gain varies slowly in the mobile stations, it is possible to provide time diversity effect and frequency diversity effect at the same time without continuing a situation of short delay spread.

The embodiments of the present invention have been explained.

CDD may be referred to as “CSD (cyclic shift diversity).” A CP may be referred to as a “guard interval (GI).” A subcarrier may be referred to as a “tone.” Further, a base station may be referred to as a “Node B” and a mobile station may be referred to as a “UE.”

Although cases have been explained above with the embodiments where the number of antennas in the base station is four, the number is not limited to four. For example, if the base station in Embodiment 2 has five antennas, two combinations are included in 1 TTI and maximize the difference between the numbers of cyclic delay shift samples, 2N/5. Further, if the base station in Embodiment 2 has six antennas, three combinations are included in 1 TTI and maximize the difference between the numbers of cyclic delay shift samples, N/2.

Further, although cases have been explained with the embodiments above where the mobile station has two antennas, the number of antennas in the mobile station is not limited to two. Further, the number of antennas in the mobile station does not depend on the number of antennas in the base station.

Further, although cases have been explained with the embodiments above where the base station reports the numbers of cyclic delay shift samples as control information to the mobile station, for example, the base station and the mobile station may hold the same shift patterns of the numbers of cyclic delay shift samples and the mobile station may determine the numbers of cyclic delay shift samples on a per TTI basis as in the base station.

Further, although cases have been described with the above embodiments where the radio communication apparatus is base station 100 and base station 300, the radio communication apparatus may be a mobile station with the present invention. By this means, the mobile station providing the same advantage as described above is realized.

Further, although eases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSIs, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosures of Japanese Patent Application No. 2007-183475, filed on Jul. 12, 2007, and Japanese Patent Application No. 2008-027755, filed on Feb. 7, 2008, including the specifications, drawings and abstracts, are incorporated herein by reference in their entirety.

### INDUSTRIAL APPLICABILITY

The present invention is applicable to, for example, mobile communication systems.

1-13. (canceled)

14. A radio communication apparatus transmitting multicarrier signals formed with a plurality of subcarriers based on cyclic delay diversity, the apparatus comprising:
a determination section that determines a plurality of amounts of delay of cyclic delay diversity such that a combination of two antennas varies sequentially over time, the combination maximizing a difference between two amounts of delay of cyclic delay diversity to give to the multicarrier signals transmitted individually from the two antennas among a plurality of antennas; and
a delay section that gives the plurality of determined amounts of delay of cyclic delay diversity to the plurality of multicarrier signals transmitted from the plurality of antennas.

15. The radio communication apparatus according to claim 14, wherein a maximum difference between two amounts of delay of cyclic delay diversity is half a data length of each multicarrier signal.

16. The radio communication apparatus according to claim 14, wherein the determination section determines the plurality of amounts of delay of cyclic delay diversity such that, from all combinations formed with two antennas among the plurality of antennas, a combination maximizing the difference between two amounts of delay of cyclic delay diversity varies sequentially over time.

17. The radio communication apparatus according to claim 14, wherein the determination section determines the plurality of amounts of delay of cyclic delay diversity such that a plurality of combinations maximizing the difference between the two amounts of delay of cyclic delay diversity are provided in a same unit transmission interval.

18. The radio communication apparatus according to claim 17, wherein the determination section determines the plurality of amounts of delay of cyclic delay diversity such that the plurality of combinations maximizing the difference between the two amounts of delay of cyclic delay diversity in the same unit transmission interval are half the number of the plurality of antennas.

19. The radio communication apparatus according to claim 14, wherein the determination section determines the plurality of amounts of delay of cyclic delay diversity by finding values of integral multiples of a value given by equally dividing the data length of said each multicarrier signal by the number of the plurality of antennas.

20. The radio communication apparatus according to claim 14, wherein the determination section determines transmission power for the multicarrier signals transmitted individually from the plurality of the antennas such that the transmission power for the multicarrier signals transmitted from two antennas forming a combination maximizing the difference between two amounts of delay of cyclic delay diversity is made higher and the transmission power for the multicarrier signals transmitted from antennas other than the two antennas forming the combination maximizing the difference between two amounts of delay of cyclic delay diversity is made lower,
further comprising a control section that controls the transmission power for the multicarrier signals according to the determined transmission power.

21. The radio communication apparatus according to claim 20, wherein the control section controls transmission power for data signals in the multicarrier signals.

22. The radio communication apparatus according to claim 20, wherein the control section controls transmission power for reference signals in the multicarrier signals.

23. The radio communication apparatus according to claim 14, wherein the determination section determines mapping density per unit transmission interval for a reference signals transmitted from the plurality of antennas, such that the mapping density per the unit transmission interval for the reference signals transmitted from two antennas forming a combination maximizing the difference between two amounts of delay of cyclic delay diversity, is made higher, and the mapping density per the unit transmission interval for the reference signals transmitted from antennas other than the two antennas forming the combination maximizing the difference between two amounts of delay of cyclic delay diversity, is made lower,
further comprising a mapping section that maps the reference signals to the plurality of subcarriers according to the determined mapping density.

24. The radio communication apparatus according to claim 14, wherein the determination section determines the plurality of amounts of delay of cyclic delay diversity such that, in the same unit transmission interval, the combination of two antennas maximizing the difference between two amounts of delay of cyclic delay diversity varies between different frequency domains.

25. The radio communication apparatus according to claim 14, wherein the determination section determines the plurality of amounts of delay of cyclic delay diversity such that, in the same unit transmission interval, the combination of two antennas maximizing the difference between two amounts of delay of cyclic delay diversity varies between the radio communication apparatus and other radio communication apparatuses.

26. The radio communication apparatus according to claim 25, wherein:
the determination section stores a combination pattern formed with a plurality of combinations formed by changing the combination of two antennas that maximize the difference between two amounts of delay of cyclic delay diversity sequentially over time; and
the determination section determines the plurality of amounts of delay of cyclic delay diversity using the varying combination pattern between the radio communication apparatus and other radio communication apparatuses.

27. The radio communication apparatus according to claim 25, wherein, among combination patterns formed with a plurality of combinations formed by changing the combination of two antennas that maximize the difference between two amounts of delay of cyclic delay diversity sequentially over time, the determination section uses the same combination pattern between the radio communication apparatus and other radio communication apparatuses in different unit transmission intervals, and determines the plurality of amounts of delay of cyclic delay diversity.

28. A method of determining an amount of delay of cyclic delay diversity in a radio communication apparatus transmitting multicarrier signals formed with a plurality of subcarriers based on cyclic delay diversity, the method comprising determining a plurality of amounts of delay of cyclic delay diversity such that a combination of two antennas varies sequentially over time, the combination maximizing a difference between two amounts of delay of cyclic delay diversity to give to the multicarrier signals transmitted individually from the two antennas among a plurality of antennas.
